(19) United States
(12) Patent Application Publication
(10) Pub. No.: US 2026/0204289 A1
(43) Pub. Date: Jul. 16, 2026

(54) SYSTEMS AND METHODS FOR ADVANCED VIDEO TRANSLATION MANAGEMENT SYSTEMS

(71) Applicants: Rick Udicki, Rochester Hills, MI (US); Nicholas Vujicic, Allen, TX (US)

(72) Inventors: Rick Udicki, Rochester Hills, MI (US); Nicholas Vujicic, Allen, TX (US)

(21) Appl. No.: 19/135,737

(22) PCT Filed: Dec. 7, 2023
(86) PCT No.: PCT/US2023/082883

§ 371 Date: Jun. 4, 2025

Related U.S. Application Data
(60) Provisional application No. 63/386,599, filed on Dec. 8, 2022.

(51) Int. Cl. G11B 27/031; G06F 40/58; G06V 20/40; G10L 13/02; G10L 13/08; G10L 21/034; G10L 25/57; G10L 25/78

(52) U.S. Cl. CPC G11B 27/031; G06F 40/58; G06V 20/49; G10L 13/02; G10L 13/08; G10L 21/034; G10L 25/57; G10L 25/78

(57) ABSTRACT

A system for automated video translation is provided. The system includes a computer device including at least one processor in communication with at least one memory device. The at least one processor is programmed to: a) receive a video in a first language; b) create a transcript of the video in the first language; c) segment the video transcript; d) receive a selection of a second language, wherein the selected language is different than the first language; e) generate a second language transcript of the transcript in the second language; f) generate a voiceover in the second language based on the second language transcript; g) receive a selection of a spoken language and a subtitle language; and h) generate a video with the selected spoken language and the selected subtitle language.

### CROSS REFERENCE TO RELATED APPLICATIONS

This application is a continuation of U.S. Provisional Ser. No. 63/386,599 , file Dec. 8, 2022, which is hereby incorporated by reference in its entirety.

### BACKGROUND

The field of the invention relates generally to advanced translation management systems, and more specifically, to systems and methods for automatic video translation.

Many existing translation systems require significant effort on behalf of translators and voiceover artists to generate properly translated voiceovers in different languages. This can require significant costs and resources. Accordingly, an automated system that can translate video into other languages and include subtitles and/or voiceovers is desired.

### BRIEF DESCRIPTION

In at least one embodiment, a system for automated video translation is provided. The system includes a computer device including at least one processor in communication with at least one memory device. The at least one processor is programmed to receive a video in a first language. The at least one processor is also programmed to create a transcript of the video in the first language. The at least one processor is further programmed to segment the video transcript. In addition, the at least one processor is programmed to receive a selection of a second language, wherein the selected language is different than the first language. Moreover, the at least one processor is programmed to generate a second language transcript of the transcript in the second language. Furthermore, the at least one processor is programmed to generate a voiceover in the second language based on the second language transcript. In addition, the at least one processor is also programmed to receive a selection of a spoken language and a subtitle language. In addition, the at least one processor is further programmed to generate a video with the selected spoken language and the selected subtitle language. The system may include additional, less, or alternate functionality, including that discussed elsewhere herein.

In a further embodiment, a system for automated video translation is provided. The system includes a computer device including at least one processor in communication with at least one memory device. The at least one processor is programmed to receive a request for a video. The at least one processor is also programmed to receive a selection of a spoken language and a subtitle language for the video. The at least one processor is further programmed to determine if a transcript in the subtitle language is complete. If the transcript in the subtitle language is not complete, the at least one processor is programmed to generate the transcript in the subtitle language based on a segmented video transcript. In addition, the at least one processor is programmed to determine if the voiceover in the spoken language is complete. If the voiceover in the spoken language is not complete, the at least one processor is also programmed to determine if the transcript in the spoken language is complete. If the transcript in the spoken language is not complete, the at least one processor is further programmed to generate the transcript in the spoken language based on the segmented video transcript. If the voiceover in the spoken language is not complete, the at least one processor is also programmed to generate the voiceover in the spoken language based on the spoken language transcript. Furthermore, the at least one processor is programmed to generate the video with the selected spoken language and the selected subtitle language. The system may include additional, less, or alternate functionality, including that discussed elsewhere herein.

In still a further embodiment, a system for automated video translation is provided. The system includes a computer device including at least one processor in communication with at least one memory device. The at least one processor is programmed to generate a transcript for a video. The at least one processor is also programmed to segment the video based on the transcript. The at least one processor is further programmed to translate the transcript into a second language. For each segment of the video, at least one processor is programmed to a) determine a length of speech in the first language, b) determine a length of speech in the second language, c) adjust the speech in the second language to match the length of speech in the first language, d) reduce the volume of speech in the first language, and e) apply the speech in the second language over the speech in the first language. The system may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of an exemplary process for managing translation of a video in accordance with at least one embodiment of this disclosure.

FIG. 2 illustrates a flow chart of an exemplary computer-implemented process for processing translation of a video in accordance with at least one embodiment of this disclosure.

FIG. 3 illustrates a flow chart of an exemplary computer-implemented process for generating a translated video in accordance with at least one embodiment of this disclosure.

FIG. 4 illustrates a simplified block diagram of an exemplary computer system for implementing the processes shown in FIGS. 1-3.

FIG. 5 illustrates an exemplary configuration of a client computer device shown in FIG. 4, in accordance with one embodiment of the present disclosure.

FIG. 6 illustrates an exemplary configuration of a server shown in FIG. 4, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for advanced translation management systems, and more specifically, to systems and methods for automatic video translation. A translation management system, as described herein, may include a translation management (“TM”) computer device that is in communication with a plurality of user computer devices and one or more translation servers. In an exemplary embodiment, the process is performed by the translation management (“TM”) computer device, also known as a translation management (“TM”) server. In the exemplary embodiment, the TM system provides an online end-to-end video transcription, language translation, language voiceover, and video player solution. The TM system provides language selections for both subtitles and voiceovers all leveraging AI and human-editing interface. The TM system, as described herein is configured to be third-party language agnostic. This allows the TM system to determine and generate the best solutions for specific languages, applications, and use-cases.

In the exemplary embodiment, a user provides a video and requests that the video be translated into one or more languages. The user also provides one or more languages that the user wants the video to be translated into. This may include a language for voiceovers and a language for subtitles. These languages may be different from the original language of the video. These languages may also be different from each other.

In the exemplary embodiment, the TM server segments the provided video and creates a transcript of the video in the original language. In some embodiments, the TM server segments the video based upon pauses of one or more speakers in the video. In other embodiments, the TM server segments the video based upon one or more user preferences and/or the preferences based upon the language(s) being spoken. The TM server then generates one or more translated transcripts for the video in the desired languages. The TM server uses the voiceover transcript to generate the voiceover for the video. The TM server uses the subtitle transcript to automatically generate the subtitles for the video. The TM server then integrates the voiceover and subtitles into the video. In some embodiments, the voiceover language and the subtitle video are the same and only one transcript is used for both the voiceover and the subtitles.

For example, the original video may be in French. The user may desire to have the voiceover in German with the subtitles in English. In this example, the TM server generates a German transcript and an English transcript of the video. Then the TM server generates a voiceover for the video based on the German transcript. The TM server generates subtitles for the video based on the English transcript. The TM server then integrates the German voiceover and the English subtitles into the video.

In the exemplary embodiment, the TM system provides a proprietary fading feature to fade up and down for original source volume whenever voiceover is detected. In this embodiment, the TM system lowers the volume of the original audio of the video and plays over that audio with the desired voiceover. When that section of the voiceover is complete, the volume of the original audio is restored to the original level. In some embodiments, all of the volume of the original video is lowered. In other embodiments, the TM system detects the one of more channels associated with the speaker and lowers the volume of those channels while allowing other background noises remain at their previous volume.

In the exemplary embodiment, the TM system provide artificial intelligence (AI) feature detection. The AI feature detection includes the location mapping of words and the classification of pitch, tone, tempo, intonation, etc. of those words. For example, in a yoga video the speaker may stretch out the words “Breath in” and “Breath out.” The AI feature detection would then cause the voiceover translated words to be stretched out as well. Furthermore, if the original speaker was whispering the words, then the AI feature detection detects the whispering and adjusts the voiceover to whisper the translated words as well.

In the exemplary embodiment, the TM system provides a voiceover time emulator for predicting length of each voiceover. The TM server predicts the voiceover time for each sentence to help match translation text editing. Once the voiceover is generated, actual time is determined for each voiceover sentence. The voiceover time is compared to original source to determine any differences, such as those due to differences in the length of sentences in different languages. The TM server automatically generates Markup/Markdown time enhancements based on pre-determined settings, that may be based upon speaker voice, language, tone pitch, etc. Furthermore, the AI learns patterns for voiceover adjustments.

The AI also performs automatic voice enhancements, such as matching, the tone, pitch, tempo, and/or inflection of the original speaker in the voiceover. Furthermore, the automatic voice enhancements are used to create a similar voice to the original speaker without cloning the original speaker and sounding exactly like them.

In some embodiments, an AI dialect generation based existing machine-generated languages allows the TM system to detect different dialects in a language based on speakers and other languages and their dialects.

In some other embodiments, the AI algorithm learns how to perform text summarization to shorten phrases in different languages to account for differences in the length of sentences in the original language and the translated languages. This may include cross-lingual paraphrase identification and a dictionary of other usable phrases.

In further embodiments, the TM system supports real-time translation to voiceovers for live videos supported in multiple languages. This allows for the translation of live videos with a minimal delay into a plurality of languages. For example, individuals watching a speech at the United Nations, may be able to have the speech translated into their language in real-time and/or near real-time.

In some further embodiments, the TM system supports AI voice cloning for multi-languages speech. Some individual speakers may wish to have their voices cloned into multiple languages, so that when each language is played for their video, the person speaking sounds exactly or nearly exactly like them.

In other embodiments, the TM system supports voice cloning of speakers, so that a similar voice is used in other languages. This may include detecting the speaking patterns of a speaker and then recreating those speaking patterns in a similar sounding speaker in other languages. In some embodiments, the TM system matches the pitch, tempo, frequency, harmonic structure, and intensity of the original speaker in the cloned speaker.

In an additional embodiment, the TM system supports AI transcript, translation, dictionary, and voiceover enhancement learning for continued evolving language support. This allows the AI algorithms to learn and improve transcription, translation, and voiceover by learning from historical corrections and changes to the transcriptions, translations, and voiceovers.

Accordingly, the TM computer system may create a training model and enables large language models, such as GPT (Generative Pre-trained Transformers) models, to automate the analysis of speech to determine pauses and/or other features of that speech, which may be used in recreating that speech in other languages. Moreover, the TM computer device executes the GPT model to automate pause detection, transcription creation, and voiceover generation.

In some further embodiments, the TM computer system determines the differences in natural pauses between the original speech in the first language and the speech in the second language. For the section of speech, the TM computer system readjusts one or more language-based and/or intentional pauses to adjust the flow of the section of speech in the second language. The TM computer system also adds, removes, lengthens, shortens, and/or combines pauses to adjust the total duration of the section of speech in the second language to match the original duration of the second of speech in the first language. In some embodiments, the TM computer system uses the AI to use pauses to adjust the total duration of the section of speech in the second language.

Furthermore, in the exemplary embodiment, the TM system provides a web-based end-to-end video translation voiceover solution. This includes generating transcriptions, language translations, language voiceovers. In addition, the TM system provides a video player with language selections for subtitles and voiceovers, which allow a user to dynamically change the language of the voiceover and/or subtitles. In addition, the TM system is third party service agnostic, where the TM system is configured to work with any outside third-party services.

While the above systems have been described in terms of one video, those having skill in the art would understand that the systems may be used for a plurality of videos, such as a group of videos from a specific speaker. Furthermore, videos may include, but are not limited to, lectures, television shows, movies, sermons, web videos, private videos, speeches, and/or any other type of video where translation is desired. In some embodiments, the system may translate videos in real-time or near real-time, such as by translating a live speech.

At least one of the technical problems addressed by this system may include: (i) improving speed and efficiency of translating videos; (ii) improved speed and efficiency of generating voiceovers for videos; (iii) improving accuracy in translating videos; (iv) reduced resource cost in generating translated videos; (v) constant improvement of accuracy and efficiency of translated videos; and/or (vi) streamlining the video translation process to faster process and generate translated videos.

The methods and systems described herein may be implemented (i) using computer programming or engineering techniques including computer software, firmware, hardware, or any combination or subset thereof, and/or (ii) by using one or more local or remote processors, transceivers, servers, sensors, servers, scanners, AR or VR headsets or glasses, smart glasses, and/or other electrical or electronic components, wherein the technical effects may be achieved by performing at least one of the following steps: a) receive a video in a first language; b) create a transcript of the video in the first language; c) segment the video transcript; d) receive a selection of a second language, wherein the selected language is different than the first language; e) generate a second language transcript of the transcript in the second language; f) generate a voiceover in the second language based on the second language transcript; g) receive a selection of a spoken language and a subtitle language; h) generate a video with the selected spoken language and the selected subtitle language; i) divide the video into a plurality of segments; j) generate the transcript of the video using the plurality of segments in the video; k) detect at least one pause in a speech of a speaker during the video; l) annotate the transcript to include the at least one pause; m) generate the voiceover to include the at least one pause indicated in the transcript; n) detect the at least one pause based upon the corresponding pause exceeding a predetermined threshold; o) generate the second language transcript to include the at least one pause indicated in the transcript; p) determine if the voiceover in the spoken language is complete; q) if the voiceover in the spoken language is not complete, determine if the transcript in the spoken language is complete; r) if the transcript in the spoken language is not complete, generate the transcript in the spoken language based on the segmented video transcript; s) if the voiceover in the spoken language is not complete, generate the voiceover in the spoken language based on the spoken language transcript; t) segment the video based on the transcript; u) translate the transcript into a second language; v) for each segment of the video, determine a length of speech in the first language; w) for each segment of the video, determine a length of speech in the second language; x) calculate a difference in the length of speech in the first language and the length of speech in the second language; y) compare the difference to one or more thresholds; z) indicate the difference in the transcript; aa) for each segment of the video, adjust the length of speech in the second language to match the length of speech in the first language; bb) adjust the length of speech in the second language by paraphrasing the speech in the first language; cc) increase the length of speech in the second language to match the length of speech in the first language; dd) decrease the length of speech in the second language to match the length of speech in the first language; ee) for each segment of the video, reduce the volume of speech in the first language; ff) for each segment of the video, apply the speech in the second language over the speech in the first language; gg) receive a selection of a subtitle language; hh) generate a set of subtitles in the subtitle language; ii) apply the subtitles to the generated video; jj) determine if a transcript in the subtitle language is complete; kk) if the transcript in the subtitle language is not complete, generate the transcript in the subtitle language based on a segmented video transcript; ll) burn the subtitles into the video; and/or mm) generate and a subtitle track to be associated with the video.

In other embodiments, the technical effects may be achieved by performing at least one of the following steps: a) receive a request for a video; b) receive a selection of a spoken language and a subtitle language for the video; c) determine if a transcript in the subtitle language is complete: d) if the transcript in the subtitle language is not complete, generate the transcript in the subtitle language based on a segmented video transcript; e) determine if the voiceover in the spoken language is complete; f) if the voiceover in the spoken language is not complete, determine if the transcript in the spoken language is complete; g) if the transcript in the spoken language is not complete, generate the transcript in the spoken language based on the segmented video transcript; h) if the voiceover in the spoken language is not complete, generate the voiceover in the spoken language based on the spoken language transcript; and i) generate the video with the selected spoken language and the selected subtitle language.

In still further embodiments, the technical effects may be achieved by performing at least one of the following steps: a) generate a transcript for a video; b) segment the video based on the transcript; c) translate the transcript into a second language; and d) for each segment of the video, 1) determine a length of speech in the first language; 2) determine a length of speech in the second language; 3) adjust the speech in the second language to match the length of speech in the first language; 4) reduce the volume of speech in the first language; and 5) apply the speech in the second language over the speech in the first language.

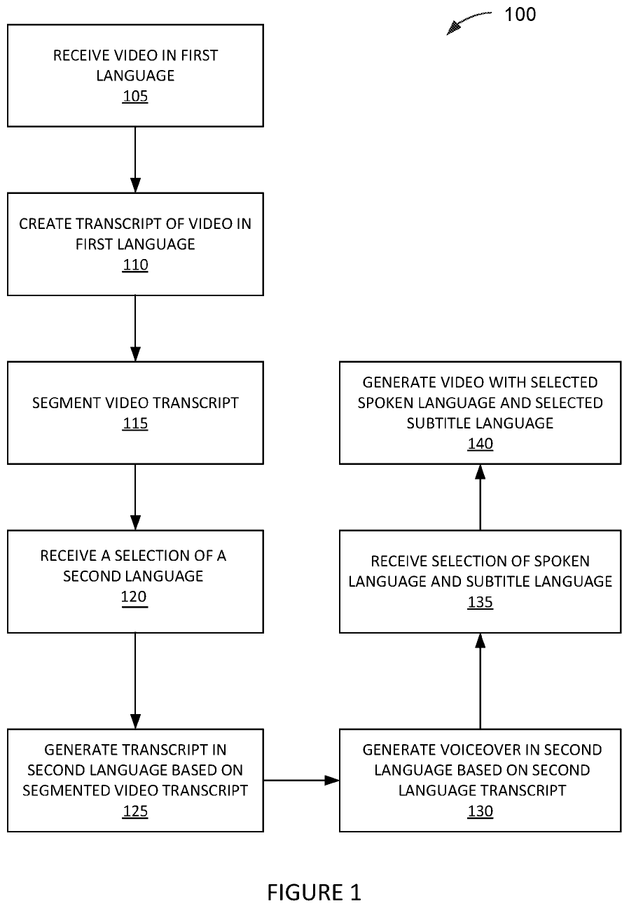

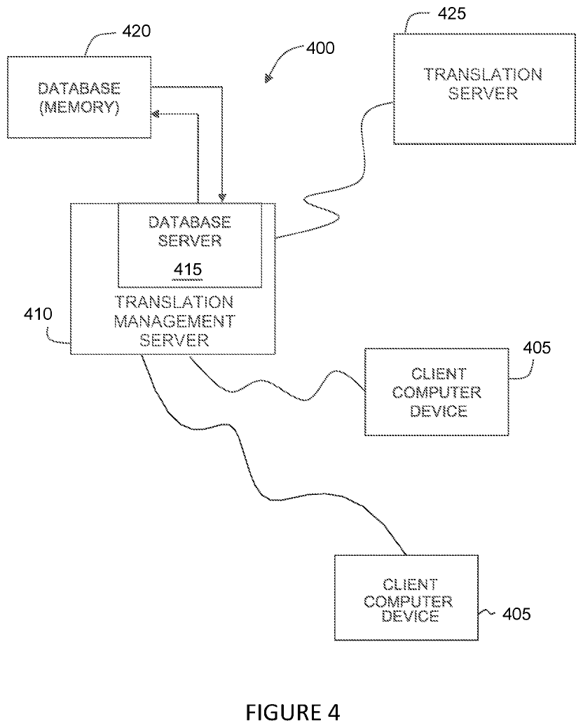

FIG. 1 illustrates a flow chart of an exemplary process 100 for managing translation of a video in accordance with at least one embodiment of this disclosure. Process 100 may be implemented by a computing device, for example TM server 410 (shown in FIG. 4). In the exemplary embodiment, the TM server 410 may be in communication with one or more translation servers 425 and one or more client computer devices 405 (both shown in FIG. 4).

In the exemplary embodiment, the TM server 410 receives 105 a video in a first language. In the exemplary embodiment, the videos include dialog form one or more speakers. In some embodiments, videos include a single speaker, such as an individual giving a lecture or a speech. In other embodiments, videos include multiple speakers, such as actors performing parts in a television show or a movie.

Videos are uploaded to the TM server 410 via a user interface on a client computer device and are encoded into segments of video in varying sizes. The encoding to varying sizes is done by the TM server 410. In some embodiments, the encoding may be performed using FFmpeg called by server-side scripts written in PHP (hypertext preprocessor). In some embodiments, the video is sliced or segmented into chunks of 2 to 5 seconds. In some embodiments, the video is segmented into chunks of video of predetermined length. In other embodiments, the video is segmented into chunks based on pauses in spoken language.

In the exemplary embodiment, the TM server 410 creates 110 a transcript of the video in the first language. In at least one embodiment, the TM server 410 creates 110 the transcript via one or more AI trained services configured to directly link objects (such as via JSON) for direct subtitle/video tracking. In some embodiments, a third-party transcription services is accessed by the TM server 410 via PHP functions. The output of the transcription system may be a JSON object in a unique format which is then converted into the TM server's format. The JSON format may include the naming of object properties and the hierarchy of sub-objects. The JSON format is configured to be parsed by the ‘editor’ and/or ‘player’ of the TM system 400.

In the exemplary embodiment, the TM server 410 segments 115 the video transcript. In some further embodiments, the TM server 410 displays the transcript in an editor that allows a user to make corrections to the transcript. In some embodiments, the user may manage the segments of the transcript by assigning speaker identifiers, genders, voice types, and/or pitch changes. In some embodiments, the TM server 410 segments the transcript into similar segments to those used for encoding the video above. In other embodiment, the TM server 410 manages the segments of the transcript by assigning speaker identifiers, genders, voice types, and/or pitch changes. In the exemplary embodiment, an artificial intelligence (AI) algorithm uses historical assignments of speaker identifiers, genders, voice types, and/or pitch changes to train one or more models to automatically perform those assignments. In some embodiments, these assignments are based on user preferences, the user, the original language, and/or other attributes of the video.

In additional embodiments, the TM server 410 inserts pauses into the transcript. In these embodiments, the TM server 410 analyzes the video and detects pauses that have a duration of or greater than a predetermined threshold. Then the TM server 410 marks those pauses in the transcript, so that the pauses may be inserted into the voiceover. Many transcripts will have natural pauses, such as where there is punctuation, but the TM server 410 also marks additional places where the speaker paused, such as for emphasis. By marking these pauses, the TM server 410 ensures that they survive at the same places into the voiceover translations. In some embodiments, the TM sever 410 adds pauses that are all the same duration. For example, for every pause in the video that is detected over 500 ms, the TM sever 410 adds an indicator to the transcript for the voiceover to insert a pause of 500 ms. In other embodiments, the TM server 410 determines a length for each detected pause and add the length of the pause to the indicator, so that any voiceover will have a pause of the same duration as the original pause. In some further embodiments, the TM server 410 adds in indicators for sentiment (emotion), tempo, pitch, tone, and/or volume, so that those attributes may be recreated in a voiceover.

In the exemplary embodiment, the transcript includes a plurality of features including, but not limited to, client & team commenting and communications, user dictionary, find & replace, revisions/history, auto-segmenting, and team assignment & sharing. Client & team commenting and communications allow users, such as editors and/or reviewers to add comments into the transcript for review by others and/or by the TM server 410 to assist in translating and subtitling the transcript. The user dictionary allows user to add words and/or phrases with different meanings for the TM server 410 to use in translations. This may include idioms, cultural phrases, and/or other words and phrases that may not properly translate. The fine & replace provides the TM server 410 with a list of words and/or phrases to automatically replace in transcripts and/or translations. Revisions/history keeps track of previous versions of transcripts, translations, voiceovers, and/or subtitles that allows user to access, such as for correcting issues in translations. Auto-segmenting includes preferences and guidelines for the TM server 410 in performing the segmenting of video and/or transcripts. Team assignment & sharing assists the TM server 410 in determining editors, reviewers, etc. for reviewing transcripts, translations, voiceovers, and/or subtitles, such as for providing feedback to the AI to improve its training.

In the exemplary embodiment, the TM server 410 receives 120 a selection of a second language. The selected language may be different from the first language. The user may select the second language for the voiceover and/or for the subtitles. The selected languages may be the same or different from each other. In some embodiments, the selected language for the subtitles may be the same as the original language. In some embodiments, the user may select the second language via a drop-down menu.

In the exemplary embodiment, the TM server 410 generates 125 a second language transcript of the transcript in the second language. In at least one embodiment, the TM server 410 transmits the transcript to a translation server 425 to translate the transcript into a second language. In some embodiments, the TM server 410 may request multiple translations into multiple languages. In some of these embodiments, the translated transcripts are displayed to one or more users to determine if any correction are needed. In further embodiments, one or more AI algorithms may review the translated transcript to detect any errors or needed changes. In at least one embodiment, translations are changeable via dropdown, and displayed in an editor to edit and manage sections. In some of these embodiments, the TM server 410 assigns editor(s) with varying permission levels for each language.

Each translation is another transcript, but with some extra data, such as having a sentence map to be used for voiceovers. Assignees can edit translations assigned to them. The access level of a user may depend on their assigned role.

In the exemplary embodiment, the translation features also include, but are not limited to: client & team commenting and communications, user dictionary, find & replace, revisions/history, auto-segmenting, team assignment & sharing, and/or voiceover enhancements, many of which are described above. Voiceover enhancements include markings by editors, reviewers, and/or the AI of the TM server 410 to indicate variations in how the voice over should be performed, such as increased or decreased pitch and/or volume.

In the exemplary embodiment, the TM server 410 generates 130 a voiceover in the second language based on the second language transcript. In at least one embodiment, one or more AI algorithms generate 130 voiceovers directly based on translations and voice enhancement markups. The TM server 410 may provide options to generate 130 new voiceovers for an entire video, collection of videos, specific sections of a video, and/or specific sentences of the video. In at least one embodiment, the TM server 410 segments the translation into sentences matching the original transcript sentences. The target duration of each voiceover sentence is set to the actual duration of the original sentence, except in cases where there is a drastic difference in the durations. This limits the speeding-up and slowing-down of voiceovers. In at least one embodiment, the TM server 410 stores the voiceover audio files for each sentence, such as in database 420 (shown in FIG. 4) or on the server, in their normal duration (as created by the text to speech (TTS) service). Then, the sentences are sped up or slowed down when the voiceover soundtrack is generated. This may be done in the browser (when working with the editor or previewing in “no premixed voiceovers” mode) or by FFmpeg before being mixed into the original soundtrack to create a voiced-over soundtrack. The slowing down or speeding up may be done to match the time of the original segment of speech that has been translated.

In the exemplary embodiment, the voiceover features include, but are not limited to, Voiceover Enhancements (via Markup/Markdown) via SSML (Speech Synthesis Markup Language), generating new voiceovers for project/section/sentence, and proprietary fading feature to fade up and down for original source volume whenever voiceover is detected.

In the exemplary embodiment, the TM server 410 receives 135 a selection of a spoken language and a subtitle language. In some embodiments, the selection is made by a user via a user interface. The user interface may include a pull-down option or radio button to allow the user to select one or more languages. In other embodiments, the selection is made by the TM server 410 itself, where the TM server 410 has access to one or more preferences and selects a common language for translation to. This selection may be based on the current language of the video and/or any previously completed translations of the video. For example, when the TM server 410 receives 105 a video in Spanish, that video is automatically translated to English. In some of these embodiments, there is a default language for translations to be made of first. There may also be a list of languages for the videos to be translated into and the TM server 410 works down the list creating translations for each language on the list.

In the exemplary embodiment, the TM server 410 generates 140 a video with the selected spoken language and the selected subtitle language. In the exemplary embodiment, the TM server 410 detects the sections of the video with spoken text to be translated. The TM server 410 reduces the volume during those sections, such as to 10-15% of normal volume. Then the TM server 410 plays the voiceover on top of the volume reduced spoken words. The TM server 410 returns the volume of the original video when the voiceover section is complete. In some of these embodiments, the TM server 410 speeds up or slows down the play back of the voiceover to match the original spoken words as closely as possible. In some embodiments, the TM server 410 burns the subtitles into the video, so that the subtitles are a permanent part of the video. In other embodiments, the TM server 410 generates and includes a subtitle track into the video container, so that the video play may chose whether or not to display the subtitles based on its settings and/or user preference.

In some further embodiments, the TM server 410 matches the pitch, the tempo, and/or the tone of the original speaker in the playback of the voiceover.

In other embodiments, the TM server 410 supports voice cloning of speakers, so that a similar voice is used in other languages. This may include detecting the speaking patterns of a speaker and then recreating those speaking patterns in a similar sounding speaker in other languages. In some embodiments, the TM server 410 matches the pitch, tempo, frequency, harmonic structure, and intensity of the original speaker in the cloned speaker.

The TM server 410 and/or database 420 are configured to allow all files (video, audio, text) to be available as individual or combined files. These files are stored in a database 420 (shown in FIG. 4). In some embodiments, the TM server 410 automatically adds subtitles and voiceovers to the video and stores the combined video in the database 420. In other embodiments, the video player separately receives the files for the subtitles, voiceover and/or video and combines the audio track with the video prior to or while the video is being played. In some of these embodiments, the video player completes the combination for a buffer period of time beyond the point that is currently playing.

Some options that the TM server 410 tracks, include, but are not limited to: Voiceover base volume adjustment, domain-specific assignment, player customization, and/or start time control. Voiceover base volume adjustment includes where the voiceover is to be at a higher or lower volume, pitch, tempo, etc. and instructs the video player and/or TM server 410 to make those adjustments. The player customization includes one or more preferences to instruct any video player on adjustments to the video. These adjustments may be based on the specific type and/or version of the video player.

In some embodiments, the TM server 410 provides an embeddable player for access on any website, where the player recognizes the browser language preference, and plays corresponding language if available.

In some further embodiments, the TM server 410 and/or database 420 provide video files with subtitles in specific language for both and/or either subtitles & voiceover. In some embodiments, the video quality can include, but are not limited to, MP4 and/or 4K video. In some further embodiments, the TM server 410 and/or database 420 supports transcript downloads with timestamps in any format. In addition, the TM server 410 and/or database 420 supports voiceover downloads for all or specific languages, such as, but not limited to MP3 or M4A.

In additional embodiment, the TM server 410 and/or database 420 collects all requests to create a downloadable file in a special table in the database 420. Background processes (‘commands’) are launched to process the video/transcript/voiceover and create a downloadable file. A back-end system for “commands” may be a part of or in communication with the TM server 410 and also used for background encoding of videos, audio extraction, HLS stream creation. The “commands” may be processed by a network of dedicated “background processing” VPS boxes, the number of which will be scalable on demand. At the front end, a standardized interface for all background processing tasks is implemented through reusable custom.

In some embodiments, when the TM server 410 receives 105 a video for translation, the TM server 410 automatically begins translating the video to one or more languages. In some embodiments, the user may have set one or more default languages for all videos to be translated into. In other embodiments, the AI of the TM server 410 may have determined the most popular languages for the type of video and begin to prepare translations for those languages.

In at least one embodiment, the TM server 410 may create a training model and enables large language models, such as GPT (Generative Pre-trained Transformers) models, to automate the analysis of speech to determine pauses and/or other features of that speech, which may be used in recreating that speech in other languages. Moreover, the TM server 410 device executes the GPT model to automate pause detection, transcription creation, and voiceover generation.

While the above process 100 has been described in terms of one video, those having skill in the art would understand that the process 100 may be performed for a plurality of videos, such as a group of videos from a specific speaker. Furthermore, videos may include, but are not limited to, lectures, television shows, movies, sermons, web videos, private videos, speeches, and/or any other type of video where translation is desired. In some embodiments, the system may translate videos in real-time or near real-time, such as by translating a live speech.

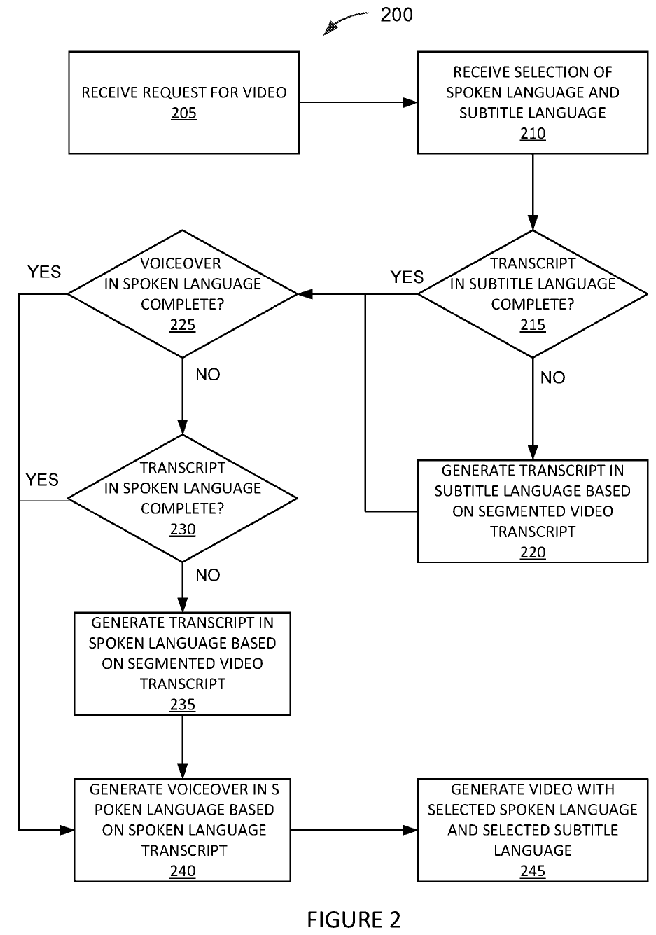

FIG. 2 illustrates a flow chart of an exemplary computer-implemented process 200 for processing translation of a video in accordance with at least one embodiment of this disclosure. Process 200 may be implemented by a computing device, for example TM server 410 (shown in FIG. 4). In the exemplary embodiment, the TM server 410 may be in communication with one or more translation servers 425 and one or more client computer devices 405 (both shown in FIG. 4).

In the exemplary embodiment, the TM server 410 receives 205 a request for a video. The request may be from a user, via a user interface on a client computer device 405. The request may also be from the system, such as when the system is working through a list containing a plurality of videos to be translated.

In the exemplary embodiment, the TM server 410 receive 210 a selection of a spoken language and a subtitle language for the video. This may be for where a user has decided that they want a translation for a video. The spoken language and the subtitle language may be different. Furthermore, the subtitle language may be the same as the original language of the video.

In the exemplary embodiment, the TM server 410 determines 215 if a transcript in the subtitle language is complete. If the transcript in the subtitle language is not complete, the TM server 410 generate 220 the transcript in the subtitle language based on a segmented video transcript. In some embodiments, the TM server 410 updates a priority of translation for the video to prioritize generating 125 a transcript in the selected subtitle language.

In the exemplary embodiment, the TM server 410 determines 225 if the voiceover in the spoken language is complete. In some embodiments, the subtitle language and the voiceover language are different. If the voiceover in the spoken language is not complete, the TM server 410 determine 230 if the transcript in the spoken language is complete. If the transcript in the spoken language is not complete, the TM server 410 generates 235 the transcript in the spoken language based on the segmented video transcript, similar to Step 125 (shown in FIG. 1). In some embodiments, the TM server 410 updates a priority of generation of the transcript for the spoken language.

If the voiceover in the spoken language is not complete, the TM server 410 generates 240 the voiceover in the spoken language based on the spoken language transcript, similar to Step 130 (shown in FIG. 1). In some embodiments, the TM server 410 updates a priority of generation of the voiceover.

In the exemplary embodiment, the TM server 410 generates 245 the video with the selected spoken language and the selected subtitle language, similar to Step 140 (shown in FIG. 1). In some embodiments, the TM server 410 updates a priority of generation of the video.

In some of these embodiments, the TM server 410 includes limited processing ability and includes a queue or priority list of desired tasks. These different tasks may have different priorities based on the user who requested them, the complexity of the task, the number of tasks, and/or other priority-based information. The TM server 410 may adjust the priorities of different tasks, such as those in process 200 to provide rapid service and processing to items that the user has requested. In other embodiments, the TM server 410 is provided by one or more cloud services. In these embodiments, the TM server 410 may request additional processing resource to perform higher priority processing, as described herein.

In some embodiments, there is only a selected voiceover language and/or only a selected subtitle language. In these embodiments, the TM server 410 determines if the desired object is complete and prioritized the processing of any needed item to complete the video.

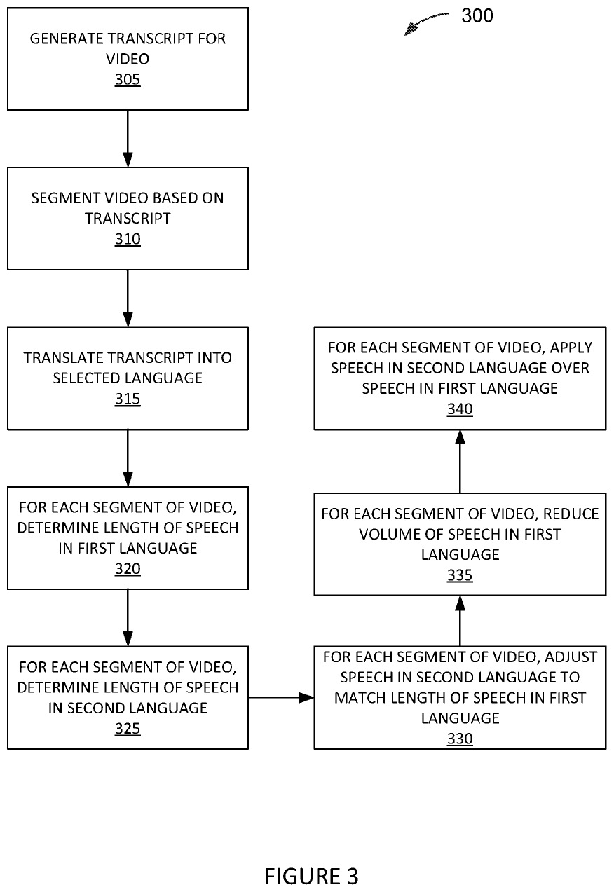

FIG. 3 illustrates a flow chart of an exemplary computer-implemented process 300 for generating a translated video in accordance with at least one embodiment of this disclosure. Process 300 may be implemented by a computing device, for example TM server 410 (shown in FIG. 4). In the exemplary embodiment, the TM server 410 may be in communication with one or more translation servers 425 and one or more client computer devices 405 (both shown in FIG. 4).

In the exemplary embodiment, the TM server 410 generates 305 a transcript for a video. The transcript may be created similar to Step 110 (shown in FIG. 1).

In the exemplary embodiment, the TM server 410 segments 310 the video based on the transcript. In some embodiments, the TM server 410 divides the video into segments of speech based upon how the transcript illustrates pauses. In some embodiments, a base transcript include punctuation from the original video. In other embodiments, the transcript notes when pauses are made by one or more speakers and how long those pauses are. Then the pauses are used to segment the video. The TM server 410 may include one or more preferences about the length of the pauses used for segmenting the video. For example, the TM server 410 may segment the video for pauses of greater than half a second. The pause length preferences may vary by language and/or individual speaker, where certain speakers converse more quickly than others. These preferences may be set by one or more users and/or the AI of the TM server 410. In the exemplary embodiment, the TM server 410 segments the video so that there is no overlap of pauses. For example, if the pause is 0.6 seconds, the TM server 410 segments the video so that the first segment of speech has 0.3 seconds of the pause at the end of its segment and the following segment of speech has 0.3 seconds of the pause at the beginning of that segment. In other embodiments, the pauses are not divided evenly, so that the first segment of speech has 0.2 seconds of the pause at the end and the second segment of speech has 0.4 seconds of the pause at the beginning. In some embodiments, the AI of the TM server 410 determines the optimal pause length for each segment of speech, such as based on the text in each segment. In some of these embodiments, the TM server 410 segments 310 the video after translating 315 the transcript and determines the segments of speech and pause segmentation based upon the original transcript and the translated transcript.

In the exemplary embodiment, the TM server 410 translates 315 the transcript into a second language. This may be similar to Step 125 (shown in FIG. 1). The translation of the transcript may be based on a language that was selected by a user and/or a default language that was set by a user and/or the AI.

For each segment of speech of the video, the TM server 410 determines 320 a length of speech in the first language. In each segment of speech, the TM server 410 determines the time that speech begins and ends in the first language. For example, in a 33 second segment of speech, the TM server 410 determines that the speaker began speaking at 1.2 seconds and stopped speaking at 31.6 seconds, giving a length of speech at 30.4 seconds long. For each segment of speech in the video, the TM server 410 also determines 325 a length of speech in the second language. The TM server 410 uses the segment of the transcript in the second language associated with the corresponding segment of video to determine how long the speech in that segment would be. Then the TM server 410 compares the length for the speech in that segment in the first language (30.4 seconds) to the length of the speech in that segment in the second language. In some situations, after translation the speech in the second language may be longer or shorter and the speech in the first language. The TM server 410 determines the difference in length between the speech in the first language and the speech in the second language. If the difference in length is less that a predetermined amount or a threshold percentage, then the TM server 410 does not adjust the length of the speech. For example, if the difference is less that 0.3 seconds, the TM server 410 keeps the second speech at the same length. In these situations, the TM server 410 may lower the volume of the video for which ever time is longer and then overlay the speech in the second speech in that block of lowered volume.

In some further embodiments, the TM server 410 determines the differences in natural pauses between the original speech in the first language and the speech in the second language. For the section of speech, the TM server 410 readjusts one or more language-based and/or intentional pauses to adjust the flow of the section of speech in the second language. The TM server 410 also adds, removes, lengthens, shortens, and/or combines pauses to adjust the total duration of the section of speech in the second language to match the original duration of the second of speech in the first language. In some embodiments, the TM server 410 uses the AI to use pauses to adjust the total duration of the section of speech in the second language.

For each segment of speech in the video, the TM server 410 adjusts 330 the speech in the second language to match the length of speech in the first language. In the exemplary embodiment, the TM server 410 determines if the difference in length between the segment of speech in the first language and segment of speech in the second language exceeds one or more thresholds based upon absolute difference and percentage difference. The thresholds may also be based on one or more settings that may be based on the first language, the second language, the speed of the original speaker, and/or any other preferences of the user or those discovered by the AI. To adjust the length of the speech, the TM server 410 may slow the speech in the second language down so that it fits within the time period of the speech of the first language. The TM server 410 may also speed the speech in the second language up so that it fits within the time period of the speech in the first language. In some embodiments, the TM server 410 may adjust the transcript to remove or add words in the second language to increase or decrease the time of the speech in the second language. In other embodiments, the TM server 410 rewrites or paraphrases the segment of speech in the second language to lengthen or shorten the speech to have the words fit in the desired time. In some further embodiments where the speech in the first segment is significantly longer than the speech in the second language, the TM server 410 may also leave the speech in the second language at its set time and just continue to lower the volume for the entire speech in the first language. This may cause a silent spot in the video but may also prevent odd sounding language.

When applying the voice over, the TM server 410 reduces 335 the volume of speech in the first language, such as to 10 or 15% of the original volume. This allows the TM server 410 to apply 340 the speech in the second language over the speech in the first language and not cause the two versions of the speech to interfere with each other. In some embodiments and/or situations, there may be blank spots where speech in the first language is occurring but has been reduced in volume.

FIG. 4 illustrates a simplified block diagram of an exemplary computer system 400 for implementing processes 100, 200, and 300 (shown in FIGS. 1-3). In the exemplary embodiment, system 400 may be used for advanced translation management, and more specifically, to systems 400 for automatic video translation. As described below in more detail, a translation management (“TM”) server 410 may be configured to receive a video in a first language, create a transcript of the video in the first language, segment the video transcript, receive a selection of a second language, generate a second language transcript of the transcript in the second language, generate a voiceover in the second language based on the second language transcript, receive a selection of a spoken language and a subtitle language, and generate a video with the selected spoken language and the selected subtitle language.

In the exemplary embodiment, client computer devices 405 are computers that include a web browser or a software application, which enables client computer devices 405 to access TM server 410 using the Internet. More specifically, client computer devices 405 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

Client computer devices 405 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In some embodiments, client computer devices 405 are capable displaying videos.

A database server 415 may be communicatively coupled to a database 420 that stores data. In one embodiment, database 420 may include translation files, videos, audio files, transcripts, and dictionaries, and/or preferences provided by the users. In the exemplary embodiment, database 420 may be stored remotely from TM server 410 and/or translation server 425. In some embodiments, database 420 may be decentralized. In the exemplary embodiment, a person may access database 420 via client computer devices 405 by logging onto TM server 410 and/or translation server 425, as described herein.

TM server 410 may be communicatively coupled with one or more the client computer devices 405. In some embodiments, TM server 410 may be associated with, or is part of a computer network associated with a video publisher, or in communication with the video publisher's computer network (not shown). In other embodiments, TM server 410 may be associated with a third party and is merely in communication with the video publisher's computer network. In some of these embodiments, the TM server 410 is associated with a translation server 425. In some embodiments, the TM server 410 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The TM server 410 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices

One or more translation servers 425 may be communicatively coupled with TM server 410. The one or more translation servers 425 each may be associated with different languages. Translation servers 425 may provide tools and/or applications for translating between languages.

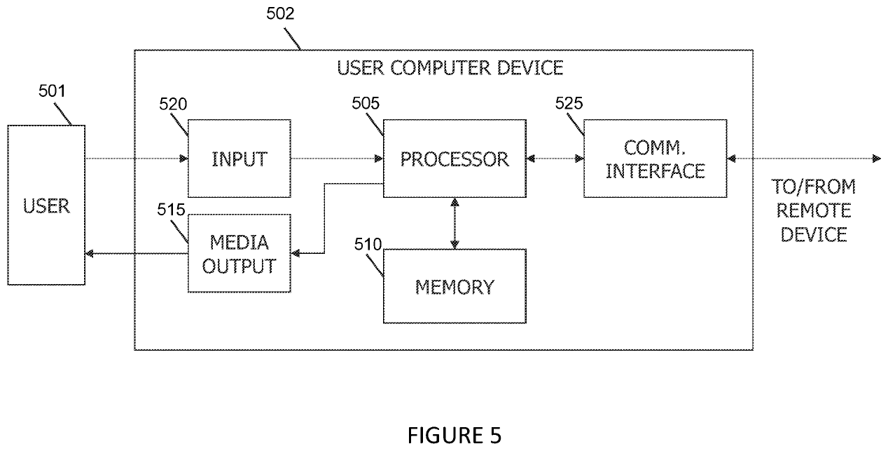

FIG. 5 depicts an exemplary configuration of a client computer device 405 shown in FIG. 4, in accordance with one embodiment of the present disclosure. User computer device 502 may be operated by a user 501. User computer device 502 may include, but is not limited to, client computer devices 405 (shown in FIG. 4). User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets).

In some embodiments, media output component 515 may be configured to present a graphical user interface (e.g., a web browser and/or a client application) to user 501. A graphical user interface may include, for example, an online store interface for viewing and/or purchasing items, and/or a wallet application for managing payment information. In some embodiments, user computer device 502 may include an input device 520 for receiving input from user 501. User 501 may use input device 520 to, without limitation, select and/or enter one or more items to purchase and/or a purchase request, or to access credential information, and/or payment information.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as the TM server 410 (shown in FIG. 4). Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from the TM server 410 and/or the translation server 425. A client application allows user 401 to interact with, for example, the TM server 410 and/or the translation server 425. For example, instructions may be stored by a cloud service, and the output of the execution of the instructions sent to the media output component 515.

Processor 505 executes computer-executable instructions for implementing aspects of the disclosure. In some embodiments, the processor 505 is transformed into a special purpose microprocessor by executing computer-executable instructions or by otherwise being programmed.

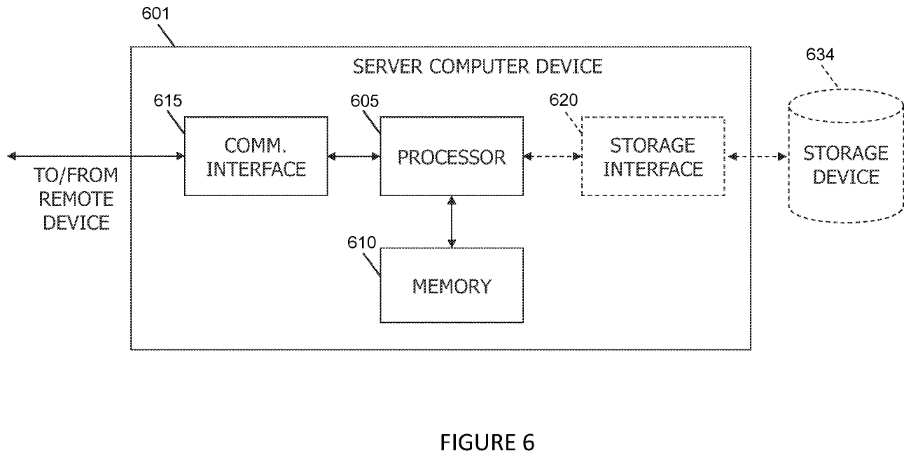

FIG. 6 depicts an exemplary configuration of a server 410 shown in FIG. 4, in accordance with one embodiment of the present disclosure. Server computer device 601 may include, but is not limited to, database server 415, TM server 410, and translation server 425 (all shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, translation server 425, or client computer devices 405 (shown in FIG. 4). For example, communication interface 615 may receive requests from client computer devices 405 via the Internet, as illustrated in FIG. 4.

Processor 605 may also be operatively coupled to a storage device 634. Storage device 634 may be any computer-operated hardware suitable for storing and/or retrieving data, such as, but not limited to, data associated with database 420 (shown in FIG. 4). In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instructions such as illustrated in FIGS. 1-3.

### MACHINE LEARNING AND OTHER MATTERS

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, TM computer system 410 is configured to implement machine learning, such that TM computer system 410 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data. ML outputs may include, but are not limited to text, voices, sounds attributes, identified objects, items classifications, textual product, and/or other data extracted from the video, audio, or textual data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of audio with known characteristics or features. Such information may include, for example, information associated with a plurality of text of a plurality of different voices, subjects, items, and/or languages.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to copy and recreate speech. The processing element may also learn how to identify attributes of different speakers and speaking patterns. This information may be used to determine pauses, pitch, tone, volume, and other attributes of speakers to be used in multiple languages.

### ADDITIONAL CONSIDERATIONS

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, NoSQL, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sy base is a registered trademark of Sy base, Dublin, California.) As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an exemplary embodiment, the system is executed on a single computer system, without requiring a connection to a server computer. In a further example embodiment, the system is being run in a Windows ® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for automated video translation comprising a computer device including at least one processor in communication with at least one memory device, wherein the at least one processor is programmed to:
receive a video in a first language;
create a transcript of the video in the first language;
segment the video transcript;
receive a selection of a second language, wherein the selected language is different than the first language;
generate a second language transcript of the transcript in the second language;
generate a voiceover in the second language based on the second language transcript; and
generate a video with the voiceover in the second language.

2. The system of claim 1, wherein the at least one processor is further programmed to:
divide the video into a plurality of segments; and
generate the transcript of the video using the plurality of segments in the video.

3. The system of claim 1, wherein the at least one processor is further programmed to:
detect at least one pause in a speech of a speaker during the video; and
annotate the transcript to include the at least one pause.

4. The system of claim 3, wherein the at least one processor is further programmed to generate the voiceover to include the at least one pause indicated in the transcript.

5. The system of claim 3, wherein the at least one processor is further programmed to detect the at least one pause based upon the corresponding pause exceeding a predetermined threshold.

6. The system of claim 3, wherein the at least one processor is further programmed to generate the second language transcript to include the at least one pause indicated in the transcript.

7. The system of claim 1, wherein the at least one processor is further programmed to:
determine if the voiceover in the spoken language is complete; and
if the voiceover in the spoken language is not complete, determine if the transcript in the spoken language is complete. if the transcript in the spoken language is not complete, generate the transcript in the spoken language based on the segmented video transcript; and
if the voiceover in the spoken language is not complete, generate the voiceover in the spoken language based on the spoken language transcript.

8. The system of claim 1, wherein the at least one processor is further programmed to:
segment the video based on the transcript;
translate the transcript into a second language;
for each segment of the video, determine a length of speech in the first language;
for each segment of the video, determine a length of speech in the second language; and
calculate a difference in the length of speech in the first language and the length of speech in the second language.

9. The system of claim 8, wherein the at least one processor is further programmed to compare the difference to one or more thresholds.

10. The system of claim 8, wherein the at least one processor is further programmed to indicate the difference in the transcript.

11. The system of claim 8, wherein the at least one processor is further programmed to for each segment of the video, adjust the length of speech in the second language to match the length of speech in the first language.

12. The system of claim 11, wherein the at least one processor is further programmed to adjust the length of speech in the second language by paraphrasing the speech in the first language.

13. The system of claim 12, wherein the at least one processor is further programmed to increase the length of speech in the second language to match the length of speech in the first language.

14. The system of claim 12, wherein the at least one processor is further programmed to decrease the length of speech in the second language to match the length of speech in the first language.

15. The system of claim 8, wherein to generate the video in the second language the at least one processor is further programmed to:
for each segment of the video, reduce the volume of speech in the first language; and
for each segment of the video, apply the speech in the second language over the speech in the first language.

16. The system of claim 1, wherein the at least one processor is further programmed to:
receive a selection of a subtitle language;
generate a set of subtitles in the subtitle language; and
apply the subtitles to the generated video.

17. The system of claim 16, wherein the at least one processor is further programmed to:
determine if a transcript in the subtitle language is complete; and
if the transcript in the subtitle language is not complete, generate the transcript in the subtitle language based on a segmented video transcript.

18. The system of claim 16, wherein the at least one processor is further programmed to burn the subtitles into the video.

19. The system of claim 16, wherein the at least one processor is further programmed to generate and a subtitle track to be associated with the video.

20. A computer-implemented method for automated video translation implemented on a computer device including at least one processor in communication with at least one memory device, wherein the method comprises:
receiving a video in a first language;
creating a transcript of the video in the first language;
segmenting the video transcript;
receiving a selection of a second language, wherein the selected language is different than the first language;
generating a second language transcript of the transcript in the second language;
generating a voiceover in the second language based on the second language transcript; and
generating a video with the voiceover in the second language.
